(19) United States
(12) Patent Application Publication
(10) Pub. No.: US 2022/0346615 A1
(43) Pub. Date: Nov. 3, 2022

(54) CHARGING MOUNT FOR VACUUM CLEANER AND VACUUM CLEANER ASSEMBLY

(71) Applicant: Shenzhen Shermon Technology Co., Limited, Shenzhen (CN)

(72) Inventor: Rongrong CHEN, Shenzhen (CN)

(21) Appl. No.: 17/343,725

(22) Filed: Jun. 9, 2021

(30) Foreign Application Priority Data
Apr. 29, 2021 (CN) 202120924400.7

(51) Int. Cl. A47L 9/28; A47L 5/28; A47L 9/24; A47L 9/00; A47L 9/04; A47L 9/32; H02J 7/00

(52) U.S. Cl. CPC A47L 9/2873; A47L 5/28; A47L 9/244; A47L 9/248; A47L 9/246; A47L 9/009; A47L 9/04; A47L 9/325; H02J 7/0042

(57) ABSTRACT

The present disclosure provides a charging mount and a vacuum cleaner assembly including the charging mount and a vacuum cleaner. The support member is provided with the curved plate clamped by the claw of the fastening head, achieving a quick fixing of the vacuum cleaner to the charging mount. Once the fastening head is engaged with the curved plate, the first electrical contact can be accurately contact the second electrical contact to ensure a stable electrical connection, resulting in stable charging. The first baseplate is provided with a plurality of securing columns for fixing and mounting spare accessories, resulting in convenience for arrangement. The seating groove and the limiting plate of the second baseplate as well as the limiting block of the first baseplate contribute to secure and limit the position of the brush head portion, resulting a stable placement of the vacuum cleaner on the charging mount.

### CROSS-REFERENCE TO RELATED APPLICATIONS

This application claims priority to Chinese Patent Application No. 202120924400.7, filed Apr. 29, 2021, which is hereby incorporated by reference herein as if set forth in its entirety.

### TECHNICAL FIELD

The present disclosure relates to a field of cleaning appliance technology, and particularly to charging mount for a vacuum cleaner and a vacuum cleaner assembly

### BACKGROUND

At present, people are increasingly pursuing a healthy and clean life style, and a spotless house. Consequently, vacuum cleaners have become primary cleaning tools in people's life. The use of the vacuum cleaners with high working efficiency in daily household duties greatly reduces people's burden for cleaning and thus assists in maintaining a clean and neat home environment. Thus, the vacuum cleaners have become favorite in households pursuing neatness. With a rapid development of the vacuum cleaners, an old-fashioned vacuum cleaner, which requires an external wire with a plug to be electrically connected with a socket on the wall for power supply during use, has been phased out. Instead, a new-fashioned vacuum cleaner is developed with and in-built battery storing electric energy, and is placed on a charging mount after use to charge the battery for later use. A contact surface between the charging mount and a brush head bottom of the vacuum cleaner is a horizontal plane, the vacuum cleaner has its position limited by positioning ribs of the charging mount when charging, and no fixing means for placing other accessories of a brush head portion is provided on the charging mount. The charging mount of such the structure has several problems in use. On one hand, the vacuum cleaner has its position limited merely by the positioning ribs when charging, resulting in a poor electrical contact between the charging mount and the vacuum cleaner. On the other hand, positioning holes provided on the vacuum cleaner need to be completely aligned with the positioning ribs provided on the charging mount to realize charging, resulting in inconvenience for operation. Further, with the positioning ribs, motion interference between the vacuum cleaner and charging tabs is probable, which causes the charging mount to be taken up when the vacuum cleaner is lifted, and results in a risk of scratching the machine by the positioning ribs and the charging tabs. In addition, spare parts of the vacuum cleaner can not be fixed on the charging mount, resulting in inconvenience for the use and arrangement of the spare parts.

### SUMMARY

The present disclosure provides a charging mount and a vacuum cleaner assembly for solving the aforementioned problems.

The present application is realized by the following technical solutions.

According to an embodiment of the present disclosure, a charging mount for a vacuum cleaner is provided, including a first baseplate, a second baseplate and a support member. The support member is fixed on the first baseplate, the first baseplate is fixed to the second baseplate, and a groove is defined between the first baseplate and the second baseplate. The support member is provided with a curved plate a first electrical contact and a charging component, the charging component is fixed inside the support member, and the first electrical contact is electrically connected to the charging component and protrudes beyond a surface of the curved plate. The first baseplate is provided with a plurality of securing columns configured to place and secure accessories for the vacuum cleaner.

In one embodiment, the first baseplate is provided with two limiting blocks fixed on a joint between the first baseplate and the second baseplate.

In one embodiment, the second baseplate defines a seating groove thereon configured to place a brush head portion of the vacuum cleaner, and the second baseplate is further provided thereon with a limiting plate configured to limit a placing position of the brush head portion.

In one embodiment, the charging mount further includes a power plug connected with the charging component through a wire.

According to a further embodiment of the present disclosure, a vacuum cleaner assembly is provided including a charging mount of the aforementioned aspect and a vacuum cleaner. The vacuum cleaner includes a telescopic handle and a fastening head fixed to the telescopic handle.

In one embodiment, the fastening head is provided with a claw, and when the vacuum cleaner is placed on the charging mount for charging, the fastening head is engaged with the curved plate by the claw clamping the curved plate.

In one embodiment, the vacuum cleaner further includes a brush head portion fixed to the telescopic handle, and the brush head portion is configured to be placed on the second baseplate.

In one embodiment, the vacuum cleaner further comprises a second electrical contact electrically connected with the brush head portion, and the second electrical contact protrudes from an inner side of the telescopic handle and extends beyond an outer surface of the fastening head.

In one embodiment, the brush head portion is further provided with one or more wheels, when the second baseplate is placed on the second baseplate, the limiting blocks abut against the wheels.

The present disclosure has advantages as follows.

The present disclosure provides a charging mount and a vacuum cleaner assembly. The support member is provided with the curved plate which can be clamped by the claw of the fastening head, so as to achieve a quick fixing of the vacuum cleaner to the charging mount. Once the fastening head is engaged with the curved plate, the first electrical contact can be accurately contact the second electrical contact to ensure a stable electrical connection, resulting in stable charging. The first baseplate is provided with a plurality of securing columns for fixing and mounting spare accessories, resulting in convenience for arrangement. The seating groove and the limiting plate of the second baseplate as well as the limiting block of the first baseplate contribute to secure and limit the position of the brush head portion, resulting a stable placement of the vacuum cleaner on the charging mount.

### BRIEF DESCRIPTION OF THE DRAWINGS

FIG. 1 is a schematical structural view of a charging mount for a vacuum cleaner according to the present disclosure.

FIG. 2 is a schematical structural view of a vacuum cleaner according to the present disclosure.

FIG. 3 is a schematical structural view of a vacuum cleaner assembly in which the charging mount and the vacuum cleaner are assembled.

### DETAILED DESCRIPTION

The present disclosure will be further described below with reference to the accompanying drawings for more clearly and fully discussing the technical solutions of the present disclosure.

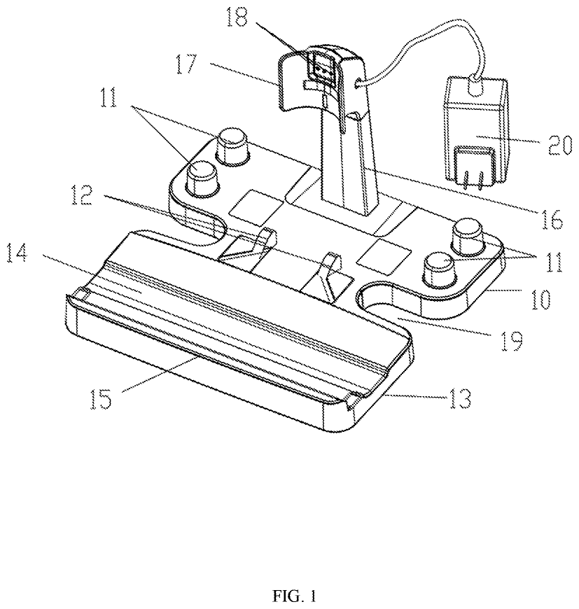

Referring to FIG. 1, a charging mount for a vacuum cleaner is provided according to an embodiment of the present disclosure, including a first baseplate 10, a second baseplate 13 and a support member 16. The support member 16 is fixed on the first baseplate 10. The first baseplate 10 is fixed to the second baseplate 13, and a groove 19 is defined therebetween. The support member 16 is provided with a curved plate 17, a first electrical contact 18 and a charging component (not labeled in the drawings). The charging component is fixed inside the support member 16. The charging component may be a circuit board to which the first electrical contact 18 is electrically connected. The first electrical contact 18 protrudes beyond a surface of the curved plate 17. The first baseplate 10 is provided with a plurality of securing columns 11 for placing and securing accessories for the vacuum cleaner. The first baseplate 10 is provided with two limiting blocks 12 which are fixed on a joint between the first baseplate 10 and the second baseplate 13. The second baseplate 13 defines a seating groove 14 thereon configured to place a brush head portion of the vacuum cleaner. The second baseplate 13 is further provided thereon with a limiting plate 15 configured to limit a placing position of the brush head portion. The charging mount further includes a power plug connected with the charging component through a wire.

In this embodiment, four securing columns 11 are provided on the first baseplate 10 and divided into two groups respectively fixed at two opposite sides of the first baseplate 10. The charging mount is further provided with the two limiting blocks 12 fixed on the joint between the first baseplate 10 and the second baseplate 13. The two limiting blocks 12 is mounted at positions corresponding to where wheels of the vacuum cleaner are placed. The first baseplate 10 is fixed to the second baseplate 13, and a groove 19 is defined therebetween. When the charging mount is placed against the wall, a stopper arranged on a floor may engage with the charging mount through the groove 19, so as to ensure a stability of the charging mount.

The charging component is component connecting the first electrical contact 18 and the wire of the power plug. As such, the first electrical contact 18 may output voltage to the vacuum cleaner only when the power plug is connected to a power supply.

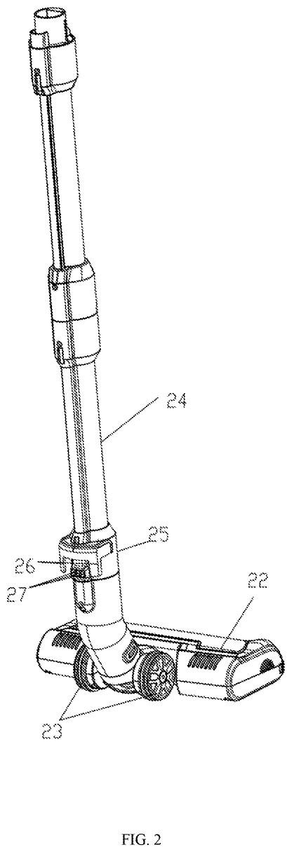

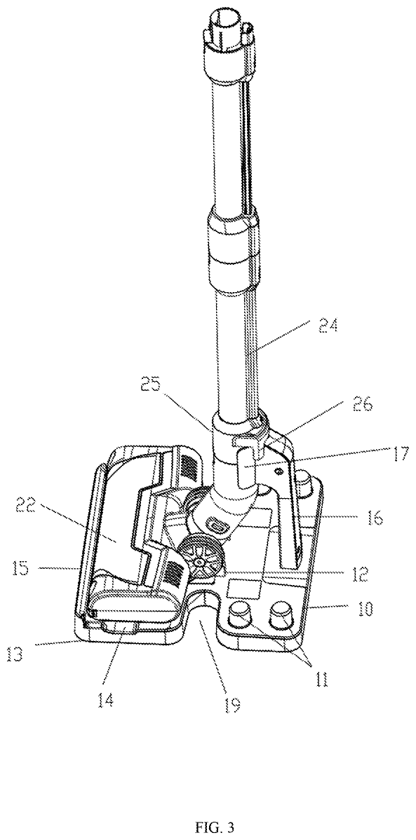

Referring to FIG. 3, a vacuum cleaner assembly is provided according to a further embodiment of the present disclosure, including a vacuum cleaner and the charging mount discussed above. Further referring to FIG. 2, the vacuum cleaner includes a telescopic handle 24 and a fastening head 25 fixed to the telescopic handle 24. The fastening head 25 is provided with a claw 26. When the vacuum cleaner is placed on the charging mount for charging, the fastening head 25 is engaged with the curved plate 17 by the claw 26 clamping the curved plate 17. The vacuum cleaner further includes a brush head portion 22 fixed to the telescopic handle 24. The brush head portion 22 may be placed on the second baseplate 13. The vacuum cleaner includes a second electrical contact 27 electrically connected with the brush head portion 22. The second electrical contact 27 protrudes from an inner side of the telescopic handle 24 and extends beyond an outer surface of the fastening head 25. The brush head portion 22 is further provided with one or more wheels 23. When the second baseplate 22 is placed on the second baseplate 13, the limiting blocks 12 abut against the wheels 23.

In this embodiment, two wheels are provided at the brush head portion 22 and correspond to the two limiting blocks 12, respectively. The telescopic handle 24 may be lengthened or shortened, so as to have its length adjustable. Two claws 26 are provided at the fastening head 25 and clamp the curved plate 17, so that the telescopic handle 24 may be securely mounted to the support member 16. The brush head portion 22 is provided inside with a battery. When the power plug is connected to the power supply and the vacuum cleaner is mounted on the charging mount with the first electrical contact 18 contacting the second electrical contact 27, the battery inside the brush head portion 22 may be charged. When the brush head portion 22 is placed on the second baseplate 13, a bottom of the brush head portion 22 is accommodated within the seating groove 14, and a front side of the brush head portion 22 abuts against the limiting plate 15 which in turn prevents the brush head portion 22 from moving ahead. Each of the first electrical contact 18 and the second electrical contact 27 is provided with three contacts. The brush head portion 22 is detachable from the telescopic handle 24. The telescopic handle 24 is also provided inside with a battery. When the vacuum cleaner and the charging mount are assembled for charging, the charging mount may charge both the batteries of the brush head portion 22 and the telescopic handle 24.

It should be noted that the present disclosure may have other various embodiments. Modifications and variations made by those skilled in the art based on the embodiments according to the present disclosure without any creative work also fall within the scope of the present disclosure.

What is claimed is:

1. A charging mount for a vacuum cleaner, comprising a first baseplate, a second baseplate and a support member, wherein the support member is fixed on the first baseplate, the first baseplate is fixed to the second baseplate, and a groove is defined between the first baseplate and the second baseplate; the support member is provided with a curved plate a first electrical contact and a charging component, the charging component is fixed inside the support member, and the first electrical contact is electrically connected to the charging component and protrudes beyond a surface of the curved plate; the first baseplate is provided with a plurality of securing columns configured to place and secure accessories for the vacuum cleaner.

2. The charging mount according to claim 1, wherein the first baseplate is provided with two limiting blocks fixed on a joint between the first baseplate and the second baseplate.

3. The charging mount according to claim 1, wherein the second baseplate defines a seating groove thereon configured to place a brush head portion of the vacuum cleaner, and the second baseplate is further provided thereon with a limiting plate configured to limit a placing position of the head portion.

4. The charging mount according to claim 1, further comprising a power plug connected with the charging component through a wire.

5. A vacuum cleaner assembly, comprising a charging mount and a vacuum cleaner, wherein the charging mount comprises a first baseplate, a second baseplate and a support member, the support member is fixed on the first baseplate, the first baseplate is fixed to the second baseplate, and a groove is defined between the first baseplate and the second baseplate; the support member is provided with a curved plate a first electrical contact and a charging component, the charging component is fixed inside the support member, and the first electrical contact is electrically connected to the charging component and protrudes beyond a surface of the curved plate; the first baseplate is provided with a plurality of securing columns configured to place and secure accessories for the vacuum cleaner.

6. The vacuum cleaner assembly according to claim 5, wherein the vacuum cleaner comprises a telescopic handle and a fastening head fixed to the telescopic handle.

7. The vacuum cleaner assembly according to claim 6, wherein the fastening head is provided with a claw, and when the vacuum cleaner is placed on the charging mount for charging, the fastening head is engaged with the curved plate by the claw clamping the curved plate.

8. The vacuum cleaner assembly according to claim 6, wherein the vacuum cleaner further comprises a brush head portion fixed to the telescopic handle, and the brush head portion is configured to be placed on the second baseplate.

9. The vacuum cleaner assembly according to claim 8, wherein the second baseplate defines a seating groove thereon configured to place the brush head portion, and the second baseplate is further provided thereon with a limiting plate configured to limit a placing position of the brush head portion.

10. The vacuum cleaner assembly according to claim 8, wherein the vacuum cleaner further comprises a second electrical contact electrically connected with the brush head portion, and the second electrical contact protrudes from an inner side of the telescopic handle and extends beyond an outer surface of the fastening head.

11. The vacuum cleaner assembly according to claim 10, wherein the brush head portion is further provided with one or more wheels, the first baseplate is provided with one or more limiting blocks, and when the second baseplate is placed on the second baseplate, the one or more limiting blocks abut against the one or more wheels.

12. The vacuum cleaner assembly according to claim 10, wherein the first baseplate is provided with two limiting blocks fixed on a joint between the first baseplate and the second baseplate.

13. The vacuum cleaner assembly according to claim 5, wherein the charging mount further comprises comprising a power plug connected with the charging component through a wire.
